(19) United States
(12) Patent Application Publication
(10) Pub. No.: US 2026/0240178 A1
(43) Pub. Date: Aug. 20, 2026

(54) GREEN TEA EXTRACT HAVING ANTIBACTERIAL EFFECT AGAINST HEAT-RESISTANT SPORE-FORMING MICROORGANISMS, AND USE THEREOF

(71) Applicant: CJ CHEILJEDANG CORPORATION, Seoul (KR)

(72) Inventors: Jinhee HAN, Seoul (KR); Soo Min LEE, Seoul (KR); Eun Sung CHO, Seoul (KR); Sung Eun PARK, Seoul (KR)

(73) Assignee: CJ CHEILJEDANG CORPORATION, Seoul (KR)

(21) Appl. No.: 19/489,557

(22) PCT Filed: May 31, 2024
(86) PCT No.: PCT/KR2024/007484

§ 371 Date: Dec. 2, 2025

(30) Foreign Application Priority Data
Jun. 2, 2023 (KR) 10-2023-0071795

(51) Int. Cl. A23B 2/771; A23L 23/00

(52) U.S. Cl. CPC A23B 2/771; A23L 23/00

(57) ABSTRACT

The present disclosure relates to a green tea extract having an antibacterial effect against heat-resistant spore-forming microorganisms, and use thereof.

### TECHNICAL FIELD

The present disclosure relates to a green tea extract having an antibacterial effect against heat-resistant spore-forming microorganisms, and use thereof.

### BACKGROUND ART

Spore-forming microorganisms can alter the flavor and odor of food when they grow to levels inappropriate for food safety standards. Spores formed by these bacteria are a major cause of food spoilage. They are primarily found on the surface, and thus can be easily mixed into food raw materials, and they are also known to be highly heat-resistant. In particular, contamination by spore-forming Bacillus microorganisms and spores formed therefrom causes organoleptic quality deterioration due to sour taste, and in severe cases, causes gas generation and swelling, etc. Therefore, the design and application of appropriate sterilization processes are required.

Consequently, in the food manufacturing industry, methods such as heat-treating foods, followed by sterilization, or applying preservatives after a sterilization process are employed in order to eliminate spore-forming microorganisms.

However, among spore-forming microorganisms, Bacillus sporothermodurans is known to have very strong heat resistance at high temperatures compared to other strains of Bacillus spp., and excessive heat treatment processes to remove these heat-resistant spore-forming microorganisms can cause deterioration of food quality due to high temperatures.

Additionally, methods to eliminate heat-resistant spore-forming microorganisms may comprise methods of using synthetic preservatives in food or subjecting foods to retort processing, thereby killing the microorganisms, but each food type has a restriction on use. Further, retort foods carry risks due to minimal heat treatment for preventing quality deterioration, and the use of antimicrobial agents for preservation purposes is subject to regulatory restrictions. Therefore, a natural extract material with a preventive purpose is required to control spore-forming microorganisms.

Accordingly, the development of a natural substance that does not lose its antibacterial effect and is safe to consume, while minimizing denaturation caused by other proteins, fats, sugars, or salts in the food when mixed into the food or denaturation caused by external environmental changes during food manufacturing and sterilization processes, storage, and distribution processes, etc. is required.

### DISCLOSURE

### Technical Problem

The present disclosure is to provide a green tea extract having an antibacterial effect against heat-resistant spore-forming microorganisms, and use thereof.

### Technical Solution

It is one object of the present disclosure to provide an antibacterial composition against heat-resistant spore-forming microorganisms, comprising a green tea extract as an active ingredient.

It is another object of the present disclosure to provide a food comprising the antibacterial composition of the present disclosure.

It is still another object of the present disclosure to provide a method for inhibiting heat-resistant spore-forming microorganisms in a retort food, comprising adding a green tea extract during the process of preparing the retort food.

It is yet another object of the present disclosure to provide a method for preparing retort soups or sauces, comprising the steps of: adding a green tea extract to soups or sauces, and then subjecting the soups or the sauces to retort processing.

### Advantageous Effects

The present disclosure provides an antibacterial composition against heat-resistant spore-forming microorganisms, which comprises a natural substance that does not lose its antibacterial effect against heat-resistant spore-forming microorganisms and is safe to consume, while minimizing denaturation caused by other proteins, fats, sugars, or salts in the food when mixed into the food, or denaturation caused by external environmental changes during food manufacturing and sterilization processes, storage, and distribution processes, etc., and the composition can be applied to retort foods, etc.

### DETAILED DESCRIPTION OF PREFERRED EMBODIMENTS

The present disclosure will be described in detail as follows. Meanwhile, each description and embodiment disclosed in this disclosure may also be applied to other descriptions and embodiments. That is, all combinations of various elements disclosed in this disclosure fall within the scope of the present disclosure. Additionally, the scope of the present disclosure is not limited by the specific description described below. Further, a number of papers and patent documents are referenced and cited throughout this specification. The disclosures of the cited papers and patent documents are incorporated herein by reference in their entirety to further clarify the level and scope of the subject matter to which the present disclosure pertains.

One aspect of the present disclosure provides an antibacterial composition against heat-resistant spore-forming microorganisms, comprising a green tea extract as an active ingredient.

As used herein, the term “spore-forming microorganism” refers to a microorganism that forms spores, which are the main cause of spoilage of food by being mixed into food raw materials. Since the spores are primarily found on the surface, they are easily mixed into food raw materials, and are also known to be highly heat-resistant. In particular, contamination by spore-forming Bacillus microorganisms and spores formed therefrom causes organoleptic quality deterioration due to sour taste, and in severe cases, causes gas generation and swelling, etc. Therefore, the design and application of appropriate sterilization processes are required.

Accordingly, the present disclosure provides an antibacterial composition against spore-forming microorganisms, which comprises a natural substance that does not lose its antibacterial effect against spore-forming microorganisms and is safe to consume, while minimizing denaturation caused by other proteins, fats, sugars, or salts in the food when mixed into the food, or denaturation caused by external environmental changes during food manufacturing and sterilization processes, storage and distribution processes, etc.

Specifically, the spore-forming microorganism of the present disclosure may be a heat-resistant spore-forming microorganism. For example, the spore-forming microorganism of the present disclosure may have a D₁₄₀-value of 3.4 to 7.9 seconds, a D₁₂₀-value of 79 to 135 seconds, but is not limited thereto, and may comprise a spore-forming microorganism having heat-resistance at 100° C. or higher. In one example, the spore-forming microorganism of the present disclosure may be a microorganism of the Bacillus spp., specifically, it may be Bacillus sporothermodurans, Bacillus amyloliquefaciens, or Bacillus subtilis, and more specifically Bacillus sporothermodurans, but is not limited thereto, and any spore-forming microorganisms whose growth is inhibited by the antibacterial composition of the present disclosure may fall within the scope of the present disclosure.

The antibacterial composition of the present disclosure may comprise a green tea extract.

As used herein, the term “extract” refers to a resulting product, such as a liquid component obtained by immersing a desired material in various solvents followed by extraction for a predetermined period of time at room temperature, at low temperature, or in a heated state; a solid component obtained by removing the solvent from the liquid component; etc. Moreover, the extract may be comprehensively interpreted to comprise all of a diluted solution of the resulting products, a concentrated solution thereof, a crude product thereof, a purified product thereof, etc., in addition to the above resulting products.

In the present disclosure, the extract may be an extract of green tea (Camellia sinensis). The extract may be obtained by extraction with various organic solvents, such as water or a medium, alcohol, etc. In particular, the organic solvent used is not particularly limited, as long as an extract can be obtained. In one example, it may be water, a polar solvent, or a non-polar solvent. In another example, it may be water, ethanol (alcohol), trichloroethylene, methylene chloride, or a mixed solvent thereof, but is not limited thereto. In addition, extraction may be performed using carbon dioxide as a solvent.

Additionally, the method of obtaining the extract is not particularly limited as long as the green tea extract can be obtained, and it may be extracted according to a method commonly used in the art. For example, the extraction method may comprise a hot water extraction method, an ultrasonic extraction method, a filtration method, a reflux extraction method, a supercritical extraction method, etc., and these may be carried out alone or in combination of two or more methods, but are not limited thereto.

The green tea may be purchased commercially, or collected or cultivated in nature.

The antibacterial composition of the present disclosure may comprise the green tea of the present disclosure in the form of an extract thereof, green tea itself, a dried product, a fermented liquid, or a fraction thereof, etc., but is not limited thereto.

In one embodiment, the antibacterial composition of the present disclosure may comprise the green tea extract in a range consisting of one lower limit selected from about 10 wt % or more, about 15 wt % or more, about 20 wt % or more, about 25 wt % or more, about 30 wt % or more, about 35 wt % or more, about 40 wt % or more, about 45 wt % or more, about 50 wt % or more, about 55 wt % or more, about 60 wt % or more, about 65 wt % or more, about 70 wt % or more, about 75 wt % or more, about 80 wt % or more, about 85 wt % or more, about 90 wt % or more, about 95 wt % or more, about 99 wt % or more, and 100 wt %, based on the total weight of the antibacterial composition, but is not limited thereto.

The green tea extract of the present disclosure may comprise polyphenols. The green tea extract may comprise polyphenols in an amount of 50 to 99.9 wt %, specifically, 80 to 99.9 wt %, based on the dry solids content of the green tea extract.

The polyphenols comprised in the green tea extract of the present disclosure are divided into subcategories such as phenolic acids, coumarins, flavonoids, lignans, and stilbenes. For the purposes of the present disclosure, the polyphenols may comprise catechins, a type of flavonoid. The green tea extract may comprise catechins in an amount of 50 to 90 wt %, specifically, 55 to 80 wt %, based on the dry solids content of the green tea extract.

Specifically, the catechins comprised in the green tea extract of the present disclosure may be epigallocatechin gallate (EGCG), epigallocatechin (EGC), epicatechin (EC), epicatechin gallate (ECG), gallocatechin gallate (GCG), DL-catechin (DL-C), and combinations thereof.

More specifically, the catechins exhibiting antibacterial activity comprised in the green tea extract of the present disclosure may be epi-catechins, and the epi-catechins may be epigallocatechin gallate, epigallocatechin, epicatechin, epicatechin gallate, and combinations thereof. Among them, epigallocatechin gallate may have the greatest effect on antibacterial activity.

Based on the dry solid content of the green tea extract, the green tea extract may comprise epigallocatechin gallate in an amount of 20 to 70 wt %, specifically 20 to 50 wt %, the green tea extract may comprise the epigallocatechin in an amount of 2 to 20 wt %, specifically 15 to 19 wt %, the green tea extract may comprise the epicatechin in an amount of 4 to 9 wt %, the green tea extract may comprise the epicatechin gallate in an amount of 6 to 14 wt %, specifically 6 to 8 wt %, the green tea extract may comprise the gallocatechin gallate in an amount of 2 to 6 wt %, specifically 2 to 3 wt %, and the green tea extract may comprise the DL-catechin in an amount of 0.5 to 2 wt %.

As used herein, the term “antibacterial” refers to inhibiting the growth of heat-resistant spore-forming microorganisms. The green tea extract of the present disclosure not only exhibits excellent antibacterial activity against heat-resistant spore-forming microorganisms, but also maintains its antibacterial effect before and after heat treatment, and the antibacterial effect can be maintained even with extended storage periods, and even in food models with internal factors similar to retort foods.

The antibacterial composition of the present disclosure may be used in foods. The antibacterial composition of the present disclosure can be consumed, and thus can be added to foods to inhibit the growth of heat-resistant spore-forming microorganisms in the foods.

As used herein, the term “about” may be presented before a particular numerical value. The term “about” used herein comprises not only the exact number recited after the term, but also a range that is near or close to that number. Considering the context in which the number is presented, it can be determined whether any number is close to or near the particular number presented. In one example, the term “about” may refer to a range from −10% to +10% of a numerical value. In another example, the term “about” may refer to a range from-5% to +5% of a given numerical value, but is not limited thereto.

Another aspect of the present disclosure provides a food comprising the antibacterial composition of the present disclosure.

The antibacterial composition is as described above. The food may comprise the antibacterial composition in an amount of 0.05% (w/w) or more, specifically 0.1% (w/w) or 0.2% (w/w) or more, and in an amount of 1% (w/w) or less, specifically 0.9% (w/w) or 0.8% (w/w) or less. When comprised in an amount of 0.05% (w/w) or more, the antibacterial activity may be appropriately exhibited, and when comprised in an amount of 1% (w/w) or less, the antibacterial activity may be exhibited without imparting other negative properties such as organoleptic quality, color, etc. The antibacterial activity may mean inhibiting the growth of heat-resistant spore-forming microorganisms, specifically Bacillus sporothermodurans, as described above.

In the present disclosure, the food of the present disclosure may be those in which the growth of heat-resistant spore-forming microorganisms has been inhibited. For example, the food of the present disclosure may be those in which the growth of heat-resistant spore-forming microorganisms has been inhibited therein or on the exterior of the food.

The growth inhibition of heat-resistant spore-forming microorganisms may be achieved by the antibacterial effect of the antibacterial composition of the present disclosure against heat-resistant spore-forming microorganisms. Additionally, the antibacterial effect may be achieved by the antibacterial effect of the green tea extract of the present disclosure against heat-resistant spore-forming microorganisms, as described above in the previous aspect.

The “food” of the present disclosure may comprise all forms, comprising general foods, retort foods, functional foods, nutritional supplements, health foods, and food additives, etc.

In one embodiment, the food of the present disclosure may be a retort food. A retort food is a processed food intended for storage. It generally refers to a processed food in which various cooked and processed foods are sealed in a pouch-like container, and then placed in an autoclave (retort), followed by heating and sterilization at high temperatures, thereby preserving the food for a long period of time under air and light-blocked conditions, and then being ready to eat by simply reheating it. The retort food carries risks due to minimal heat treatment for preventing quality deterioration, and the use of antimicrobial agents for preservation purposes is subject to regulatory restrictions. Therefore, a natural extract substance capable of controlling spore-forming microorganisms is required for prevention. In this regard, the addition of the antimicrobial composition of the present disclosure instead of a preservative can inhibit the growth of heat-resistant spore-forming microorganisms within or on the food without a separate process, thereby achieving the same effect as adding a preservative. The antimicrobial composition of the present disclosure can be consumed as a food.

Specifically, the types of retort food of the present disclosure are not limited, as long as they can be prepared in the form of a retort food, such as rice, soup, broth, porridge, side dish, black bean sauce, curry, stew, spaghetti, stew seasoning, rice bowl sauce, etc. In one example, the retort food of the present disclosure may be soups or sauces.

The food may be prepared in various forms according to a conventional method known in the art.

The foods to which the composition of the present disclosure may be added may comprise, for example, various foods, such as rice, edible grain flour (edible grain powder), grain soup, rice bowl, noodles, rice soup, instant rice, condiments, lunch box rice, dried cooked rice, bread, edible sugars, rice cake, bibimjang, sauce, spices, edible salt, seasonings, seasoning powder, processed, frozen, dried and cooked fruits and vegetables, jelly, jam, compote, egg, milk and other dairy products, edible oils and fats, coffee, cocoa and coffee substitutes, tapioca, grain flour and grain preparations, ramen, udon, noodles, noodle soup, cold noodles, porridge, soup, soup dishes, instant foods, frozen foods, retort foods, other beverages, chewing gum, tea, vitamin complexes, health supplements, etc., but are not limited thereto.

The food of the present disclosure may comprise various herbal extracts as ingredients, food auxiliary additives, or natural carbohydrates as additional ingredients, like in general foods. Further, the food auxiliary additives may comprise food auxiliary additives common in the art, for example, flavoring agents, savory agents, coloring agents, fillers, stabilizers, etc.

Examples of the natural carbohydrates comprise monosaccharides, for example, glucose, fructose, etc.; disaccharides, for example, maltose, sucrose, etc.; and polysaccharides, for example, common sugars such as dextrins, cyclodextrins, etc., and sugar alcohols such as xylitol, sorbitol, erythritol, etc. In addition to those described above, natural flavors (e.g., rebaudioside A, glycyrrhizin, etc.) and synthetic flavors (saccharin, aspartame, etc.) may be advantageously used as flavoring agents. Additionally, common food additives used for the purpose of supplementing taste and nutrition, for example, nucleic acids, amino acids, organic acids, etc., may be added.

In addition to those described above, the food of the present disclosure may comprise various nutrients, vitamins, minerals (electrolytes), flavors such as synthetic flavors and natural flavors, etc., coloring agents and fillers (cheese, chocolate, etc.), pectic acid and salts thereof, alginic acid and salts thereof, organic acids, protective colloidal thickeners, pH adjusters, stabilizers, preservatives, glycerin, alcohols, carbonation agents used in carbonated drinks, etc. In addition, the food may comprise fruit flesh for the preparation of natural fruit juices, fruit juice beverages and vegetable beverages. These components may be used independently or in combination.

The food of the present disclosure may be prepared by a method commonly used in the art, and may be prepared by adding raw materials and ingredients commonly added in the art during preparation. Additionally, the food may be prepared in any formulation without limitation as long as the formulation is recognized as a food.

Further, when the food of the present disclosure is used as a health functional food, the food of the present disclosure may be prepared in various types of formulations, and unlike general medicines, since the food is used as a raw material, there are advantages of being free from side effects that may occur when a medicine is taken for a long period of time, and of being highly portable, and therefore, the food of the present disclosure may be ingested as a supplement.

Meanwhile, the food of the present disclosure may also comprise flavoring agents, savory agents, coloring agents, fillers, stabilizers, and flavors, which may also be classified as food additives.

As used herein, the term ‘flavor’ may refer to a material added to enhance the flavor of food. The flavor may be a material that allows foods to have excellent seasoning properties.

The flavor may be divided according to taste components. In other words, according to the taste, the flavor may be divided into neutral flavor, beef flavor, chicken flavor, pork flavor, kokumi flavor, etc.

The ‘kokumi flavor’ means a flavor that releases the flavor of kokumi, and the ‘kokumi’ is a Japanese word, and may also be expressed as ‘mouthfulness’, ‘continuity’, ‘thickness’, and ‘heartiness’ in English, and expressed as ‘rich taste’, ‘thick taste’, ‘mouth-filling taste’, ‘dense taste’, ‘sticky taste’, etc. in Korean. The ‘neutral flavor’ refers to a flavor that maximizes ‘umami’ and minimizes other flavors to produce a mild and clean taste. For example, oils such as canola oil or grapeseed oil among oils may be recognized as having a neutral flavor. The term ‘seasoning property’ may mean having a sour, sweet, salty, bitter, or umami taste, but is not limited thereto.

Still another aspect of the present disclosure provides a method for inhibiting heat-resistant spore-forming microorganisms in a retort food, comprising adding a green tea extract during the process of preparing the retort food.

Yet another aspect of the present disclosure provides a method for preparing retort soups or sauces, comprising the steps of: adding a green tea extract to soups or sauces; and subjecting the soups or the sauces comprising the green tea extract to retort processing.

In the present disclosure, the green tea extract of the present disclosure not only exhibits excellent antibacterial activity against heat-resistant spore-forming microorganisms and thus can inhibit the growth thereof, but also maintains its antibacterial effect before and after heat treatment. Additionally, the antibacterial effect can be maintained even with extended storage periods, and even in food models with internal factors similar to retort foods, thereby achieving the inhibitory effect against heat-resistant spore-forming microorganisms in retort foods, and thus can be applied to the process of preparing retort foods.

The retort food may be, but is not limited to, retort soups or sauces, may be a food having a pH of 4 to 8, specifically a pH of 5 to 7, and may have a salinity of 0.5 to 2%, specifically 0.7 to 1.5%.

A further another aspect of the present disclosure provides an antibacterial use of a green tea extract against heat-resistant spore-forming microorganisms.

A further aspect of the present disclosure provides a use of a green tea extract for preparing an antibacterial composition against heat-resistant spore-forming microorganisms.

A further aspect of the present disclosure provides a use of a green tea extract for inhibiting heat-resistant spore-forming microorganisms in foods.

A further aspect of the present disclosure provides a use of a green tea extract for inhibiting heat-resistant spore-forming microorganisms in retort foods.

A further aspect of the present disclosure provides a use of an antibacterial composition against heat-resistant spore-forming microorganisms comprising a green tea extract for inhibiting heat-resistant spore-forming microorganisms in foods.

A further aspect of the present disclosure provides a use of an antibacterial composition against heat-resistant spore-forming microorganisms comprising a green tea extract for inhibiting heat-resistant spore-forming microorganisms in retort foods.

Herein, the green tea extract, heat-resistant spore-forming microorganisms, antibacterial composition, foods, retort foods, and inhibition of heat-resistant spore-forming microorganisms are as described in previous aspects.

### MODE FOR CARRYING OUT THE INVENTION

Hereinafter, the present disclosure will be described in detail by way of Examples. However, these Examples are merely preferred Examples given for illustrative purposes, and thus, the scope of the invention is not intended to be limited to or by these Examples. Meanwhile, technical features that are not described herein can be sufficiently understood and easily carried out by those skilled in the art in the technical field of the present disclosure or in a similar technical field.

### Example 1: Confirmation of Antibacterial Effect of Green Tea Extract Against Heat-Resistant Spore-Forming Microorganisms Before and After Heat Treatment

The ingredients comprised in the green tea extract to be tested for antibacterial effects against heat-resistant spore-forming microorganisms are as shown in Table 1 below based on the dry solid content of the extract. As a control for the green tea extract, grape seed extract (Breko GmbH) comprising polyphenols known to have the effect of causing loss of cell membrane function by releasing substances such as internal ions or amino acids in the microorganisms to the outside of the cells, and MicroGARD® CM1-50 (IFF Nutrition & Biosciences), a commercially available antibacterial agent against heat-resistant spore-forming microorganisms, were used.

TABLE 1

| | Green tea | Green tea |
|---|---|---|
| Ingredient (%) | extract 50 | extract 70 |
| Total Polyphenols | 86.33 | 99.8 |
| Epi-catechins | 56.62 | 70.0 |
| Epigallocatechin(EGC) | 16.35 | 18.3 |
| Epicatechin(EC) | 8.02 | 4.7 |
| Epigallocatechin gallate(EGCG) | 24.86 | 40.5 |
| Epicathechin gallate(ECG) | 7.39 | 6.5 |
| DL-catechin(DL-C) | 1.5 | 0.5 |
| Gallocatechin gallate(GCG) | 2.27 | 2.00 |
| Caffeine | 1.42 | 0.60 |

A food isolate of Bacillus sporothermodurans (D₁₄₀-value: 3.4-7.9 seconds, D₁₂₀-value: 79-135 seconds), which is a heat-resistant spore-forming microorganism known to have higher heat resistance than other Bacillus strains, was obtained and streaked on TSA medium (Tryptic Soy Agar, Difco, US) and cultured at 35° C. for 24 hours. A single colony was collected and transferred to the TSB medium (Tryptic Soy Broth, Difco, US) and cultured at 35° C. for 24 hours, and the resultant was cultured in a fresh TSB medium to prepare a subculture. The subculture was centrifuged to obtain a pellet, and TSB medium corresponding to 1/10 of the volume of the pellet was added and vortexed. 0.25 mL of the subculture and 0.25 mL of 60% glycerol were added to a vial and vortexed to prepare a strain stock, which was stored at −70° C. or lower.

The thus-prepared strain stock was streaked onto TSA medium and cultured at 35° C. for 24 hours. A single colony was collected and cultured in TSB medium at 35° C. for 24 hours. In order to induce sporulation, 1 mL of the subculture was spread onto TSA+Mn²⁺ medium (TSA medium comprising 5 μg/mL MnSO₄·H₂O, sterilized at 121° C. for 15 minutes) and cultured at 35° C. for 10 days. After the culture was completed, 5 mL of sterile distilled water stored at 4° C. was added to the medium and then collected. The recovered subculture was heat-treated at 100° C. for 10 minutes to kill vegetative cells, then centrifuged at 4,000×g at 4° C. for 20 minutes to remove the supernatant, and washed with sterile distilled water 3 times. The recovered pellet after washing was suspended in 0.85% NaCl solution to prepare a spore solution and stored at 4° C. The spore solution was heat-treated at 100° C. for 10 minutes, and the final concentration was confirmed.

In order to confirm the antibacterial effect of green tea extract, grape seed extract as a control, and MicroGARD® CM1-50 against heat-resistant spore-forming microorganisms, the minimum inhibitory concentration (MIC) was determined. Specifically, 100 μL of TSB medium was dispensed from column 2 to column 11 of a 96-well plate, and 200 μL of sample stocks prepared by first dissolving each sample in a small amount of DMSO reagent and then diluting with TSB medium to a final concentration of 1 to 2% (w/v) of each sample was dispensed into column 1. The final concentration of DMSO in the sample stocks was adjusted to 5% (w/v) or less. 100 μL of each sample in column 1 was taken and dispensed into column 2, followed by binary dilution through pipetting. After stepwise binary dilution from column 3 to column 11 using the same method, 100 μL of each sample in column 11 was taken and discarded. The spore solution of Bacillus sporothermodurans was diluted in TSB medium to a final concentration of 4 to 5 log CFU/mL, and then 100 μL of the solution was dispensed into columns 1 to 11. In rows A-D of column 12, 200 μL of TSB medium was dispensed as a negative control, and in rows E-H, 100 μL of TSB medium and 100 μL of the spore solution were dispensed as positive controls. The absorbance of the plate was measured at 600 nm using a microplate reader (0 h), and the plate was incubated at 35° C. for 24 hours, and then the absorbance was measured again (24 h). The absorbances measured at 0 h and 24 h were compared, and the section with a difference of 0.05 or more was selected as the candidate section for microbial growth. When it was difficult to distinguish accurately by absorbance due to the color and turbidity of the antibacterial material, the candidate section was selected broadly. 100 μL of the sample of the candidate section was diluted 10-fold with saline solution, spread on TSA medium, and incubated at 35° C. for 48 hours, and then colonies were counted. The concentration of the sample at which the microbial growth was maintained at the level of the initial spore inoculation concentration for 24 hours after the start of incubation was determined as the MIC, and the changes in strain growth according to the concentration of each sample and the resulting antibacterial efficacy are shown in Tables 2 and 3 below.

In addition, to confirm whether each sample exhibits an antibacterial effect against heat-resistant spore-forming microorganisms even after heat treatment, each sample stock was packaged in a retort food and heat-treated at 120° C. for 18 minutes, which is the sterilization condition for retort products, to sterilize until the final F₀ became 16 to 18, and then dispensed into a 96-well plate to confirm the MIC using the same method as above.

As a result, the MIC of the grape seed extract and MicroGARD® CM1-50 increased from 0.063% to 0.125% and from 0.125% to 0.250% before and after heat treatment, respectively, confirming that the antibacterial effect decreased after heat treatment, and the antibacterial efficacy rate (%) was also low, showing 50% in both cases. In contrast, the MIC of the green tea extract was 0.063% before and after heat treatment, confirming that the antibacterial efficacy rate was 100% at the corresponding concentration, and accordingly, it was confirmed that the antibacterial effect was maintained the same before and after heat treatment and that the antibacterial efficacy rate was excellent.

TABLE 2

| | | Before heat | After heat |
|---|---|---|---|
| | | treatment | treatment |
| Sample | Concentration | (log CFU/mL) | (log CFU/mL) |
| Green tea | 0.031% | TNTC | TNTC* |
| extract 50 | 0.063% | 3.3 | 3.5 |
| Green tea | 0.031% | TNTC | TNTC |
| extract 70 | 0.063% | 3.1 | 3.1 |
| Grape seed | 0.063% | 3.5 | TNTC |
| extract | 0.125% | 3.4 | 3.4 |
| MicroGARD ® | 0.125% | 3.8 | TNTC |
| CM1-50 | 0.250% | 3.6 | 3.5 |

*TNTC (Too numerous to count, ≥6.0 log CFU/mL)

TABLE 3

| | Before heat | After heat | |
|---|---|---|---|
| | treatment | treatment | Antibacterial |
| Sample | MIC | MIC | Efficacy Rate |
| Green tea extract 50 | 0.063% | 0.063% | 100% |
| Green tea extract 70 | 0.063% | 0.063% | 100% |
| Grape seed extract | 0.063% | 0.125% | 50% |
| MicroGARD ® CM1-50 | 0.125% | 0.250% | 50% |

### Example 2: Confirmation of Maintenance of Antibacterial Effect of Green Tea Extract According to Storage Period after Heat Treatment

It was confirmed whether the antibacterial effect of the green tea extract and control grape seed extract and MicroGARD® CM1-50 against heat-resistant spore-forming microorganisms was maintained during the storage period. Each sample stock heat-treated as in Example 1 was diluted in TSB medium to 1, 4, or 8 times the MIC confirmed in Example 1, and 20 mL of each was prepared, and 20 mL of TSB medium was prepared as a negative control. The spore solution of Bacillus sporothermodurans was inoculated to a final concentration of 4 to 5 log CFU/mL and incubated at 35° C., and samples were taken on the day of the experiment (day 0), and on days 7 and 14 after the start of the experiment. The collected samples were spread on TSA medium, incubated at 35° C. for 48 hours, and colonies were counted. The concentration of the sample at which microbial growth was maintained at the level of the initial spore inoculation concentration for 14 days after the start of incubation was determined as the MIC during the storage period, and the changes in strain growth according to the concentration of each sample and the resulting antibacterial efficacy are shown in Tables 4 and 5 below.

As a result, MicroGARD® CM1-50 showed a decrease in antibacterial effect as the storage period increased, with the MIC increasing from 0.250% to 1% after 24 hours of storage, and the antibacterial efficacy rate (%) was also low at 25%. In contrast, the MIC of green tea extract 70 and grape seed extract was maintained at 0.063% and 0.125% before and after heat treatment, respectively, and the antibacterial efficacy rate was 100% at the corresponding concentrations, confirming that the antibacterial effect was maintained the same even when the storage period was prolonged and that the antibacterial efficacy rate was excellent.

TABLE 4

| | | Day 0 (log | Day 7 (log | Day 14 (log |
|---|---|---|---|---|
| Sample | Concentration | CFU/mL) | CFU/mL) | CFU/mL) |
| Negative control | — | 4.7 | 6.9 | 6.9 |
| Green tea | 0.063% | 4.6 | 6.1 | 6.3 |
| extract 50 | 0.250% | 4.5 | 2.4 | 1.5 |
| | 1.000% | 4.4 | 2.2 | 1.0 |
| Green tea | 0.063% | 4.6 | 3.0 | 2.0 |
| extract 70 | 0.250% | 4.5 | 2.7 | 1.3 |
| | 1.000% | 4.5 | 2.1 | 1.0 |
| Grape seed | 0.125% | 4.5 | 2.9 | 2.5 |
| extract | 0.500% | 4.4 | 2.3 | 1.0 |
| | 1.000% | 4.4 | 2.2 | 1.0 |
| MicroGARD ® | 0.250% | 4.5 | 7.4 | 7.1 |
| CM1-50 | 1.000% | 4.5 | 3.4 | 3.2 |

TABLE 5

| | MIC after | MIC after | |
|---|---|---|---|
| | 24 hours of | 14 days of | Antibacterial |
| Sample | storage | storage | efficacy rate |
| Green tea extract 50 | 0.063% | 0.250% | 25% |
| Green tea extract 70 | 0.063% | 0.063% | 100% |
| Grape seed extract | 0.125% | 0.125% | 100% |
| MicroGARD ® CM1-50 | 0.250% | 1.000% | 25% |

### Example 3: Confirmation of Maintenance of Antibacterial Effect of Green Tea Extract According to Change in pH

It was confirmed whether the antibacterial effect of the green tea extract, grape seed extract as a control, and MicroGARD® CM1-50 against heat-resistant spore-forming microorganisms was maintained even when the pH changed. Each sample stock heat-treated as in Example 1 was diluted in TSB medium, and 20 mL of each was prepared, and 20 mL of TSB medium was prepared as a negative control. The pH of the prepared medium was adjusted to pH 4.5, pH 6.0, and pH 7.5 using 45% lactic acid and 1 N NaOH reagent filtered through a 0.2 μm membrane filter. The spore solution of Bacillus sporothermodurans was inoculated into the pH-adjusted medium to a final concentration of 4 to 5 log CFU/mL, and incubated at 35° C. for 24 hours, and samples were taken immediately (0 h) and 24 hours after the start of incubation. The collected samples were spread on TSA medium, incubated at 35° C. for 48 hours, and colonies were counted. The concentration of the sample at which microbial growth was maintained at the level of the initial spore inoculation concentration for 24 hours after the start of incubation was determined as the MIC according to pH, and the changes in strain growth according to the concentration of each sample are shown in Table 6 below.

As a result, in the case of the negative control to which the antibacterial material was not added, the bacterial growth reached the maximum growth level after 24 hours in the pH range near neutral (6.0-7.5), but the antibacterial material treatment groups maintained the initial bacterial count level under all experimental pH conditions, confirming that the germination and/or growth inhibition effects were exhibited. In particular, among all antibacterial material treatment groups, the green tea extract 70 showed the same level of growth inhibition effect as the other two antibacterial material treatment groups at the lowest concentration of 0.063%.

TABLE 6

| | Concen- | | | pH 4.5(log | pH 6.0(log | pH 7.5(log |
|---|---|---|---|---|---|---|
| Sample | tration | Time | | CFU/mL) | CFU/mL) | CFU/mL) |
| Negative | — | 0 | h | 4.7 | 4.8 | 4.8 |
| control | — | 24 | h | 4.8 | 7.3 | 7.3 |
| Green tea | 0.25% | 0 | h | 4.4 | 4.3 | 4.3 |
| extract 50 | 0.25% | 24 | h | 4.2 | 4.1 | 3.9 |
| Green tea | 0.063% | 0 | h | 4.3 | 4.4 | 4.2 |
| extract 70 | 0.063% | 24 | h | 4.2 | 4.2 | 4.0 |
| Grape seed | 0.125% | 0 | h | 4.3 | 4.3 | 4.3 |
| extract | 0.125% | 24 | h | 4.3 | 3.9 | 3.9 |
| MicroGARD ® | 1% | 0 | h | 4.1 | 4.1 | 4.2 |
| CM1-50 | 1% | 24 | h | 4.2 | 3.7 | 4.0 |

### Example 4: Confirmation of Antibacterial Effect of Green Tea Extract Mixed in Food Against Heat-Resistant Spore-Forming Microorganisms

In order to confirm whether the antibacterial effect against heat-resistant spore-forming microorganisms was maintained when the green tea extract, grape seed extract, which is a control, and MicroGARD® CM1-50 were mixed into food, food models with internal factors similar to commercial retort foods were prepared. The pH of the foods was adjusted to pH 5.0 and pH 7.0, respectively, and the NaCl concentration in all foods was 1.0% (w/w).

Each antibacterial agent was mixed with glucose, soytone, salt, and purified water. The mixture was heated in a water bath at 90° C. while stirring at 400 rpm. Once the core temperature of the mixture reached 80° C., the mixture was stirred for an additional 20 minutes and then cooled to 25° C. The moisture lost during heating was replaced with purified water to prepare the food models. The food models prepared without mixing the samples were used as the negative control. The ingredients comprised in the food models prepared by mixing each of the above samples are as shown in Table 7 below.

TABLE 7

| | Food models | | | | |
|---|---|---|---|---|---|
| | | Green | Green | | |
| | Neg- | tea | tea | Grape | |
| Ingre- | ative | extract | extract | seed | MicroGARD ® |
| dient | control | 50 | 70 | extract | CM1-50 |
| Glucose | 0.3% | 0.3% | 0.3% | 0.3% | 0.3% |
| Soytone | 2.0% | 2.0% | 2.0% | 2.0% | 2.0% |
| NaCl | 1.0% | 1.0% | 1.0% | 1.0% | 1.0% |
| Water | 96.7% | 96.6% | 96.6% | 96.6% | 95.7% |
| Antimi- | — | 0.25% | 0.063% | 0.125% | 1.0% |
| crobials | | | | | |
| Total | 100.0% | 100.0% | 100.0% | 100.0% | 100.0% |

The thus-prepared food models were packaged in a retort food and heat-treated at 120° C. for 18 minutes, which is the sterilization condition for retort products, to sterilize until the final F₀ became 16 to 18, and then, the pH of the sterilized food models was adjusted to pH 5.0 and pH 7.0 using 11% lactic acid and 0.025 N NaOH reagent filtered through a 0.2 μm membrane filter. The pH-adjusted food models were inoculated with the spore solution of Bacillus sporothermodurans to a final concentration of 2 to 3 log CFU/mL and incubated at 35° C. Samples were taken on the day of the experiment (day 0), and on days 4, 7, and 14 after the start of the experiment. The collected samples were spread on TSA medium, incubated at 35° C. for 48 hours, and then colonies were counted. The concentration of the sample at which microbial growth was maintained at the level of the initial spore inoculation concentration for 14 days after the start of incubation was determined as the MIC, and the changes in strain growth according to the concentration of each sample are shown in Table 8 below.

As a result, in the case of the negative control group in the food model at pH 5, microbial growth was confirmed up to day 14. In contrast, the antimicrobial material treatment groups maintained microbial growth at a level below the initial inoculation level, confirming that they exhibited a microbial growth inhibition effect. The food model at pH 7 provided a more suitable environment for the growth of Bacillus sporothermodurans compared to the food model at pH 5, and it was confirmed that the negative control group grew to the maximum growth level during the storage period. In contrast, microbial growth was inhibited in the antimicrobial material treatment groups, and in particular, in the case of the green tea extract, microbial growth was not detected after day 4 of storage. In addition, considering the concentration of the antimicrobial material treatment groups used, the green tea extract 70 showed more effective microbial growth control than the other antimicrobial material treatment groups at the lowest concentration.

TABLE 8

| | | Negative | Green tea | Green tea | Grape seed | MicroGARD ® |
|---|---|---|---|---|---|---|
| Sample | | control | extract 50 | extract 70 | extract | CM1-50 |
| Concentration | | — | 0.25% | 0.063% | 0.125% | 1% |
| pH of food | Storage | B. sporothermodurans (log CFU/mL) | | | | |
| models | period of | | | | | |
| | food models | | | | | |
| pH 5 | Day 0 | 1.8 ± 0.1 | 1.5 ± 0.2 | 1.7 ± 0.2 | 1.7 ± 0.2 | 1.1 ± 0.2 |
| | Day 4 | 5.8 ± 0.1 | 1.0 ± 0.3 | 1.4 ± 0.3 | 1.2 ± 0.2 | 0.7 ± 0.2 |
| | Day 7 | 5.9 ± 0.4 | 0.8 ± 0.2 | 1.5 ± 0.2 | 1.2 ± 0.0 | 0.8 ± 0.3 |
| | Day 14 | 4.5 ± 0.5 | 0.0 ± 0.0 | 1.1 ± 0.2 | 1.1 ± 0.2 | 0.9 ± 0.2 |
| pH 7 | Day 0 | 1.8 ± 0.1 | 1.7 ± 0.2 | 1.6 ± 0.2 | 1.5 ± 0.2 | 1.2 ± 0.3 |
| | Day 4 | 7.5 ± 0.1 | ND | ND | 1.1 ± 0.8 | 0.2 ± 0.3 |
| | Day 7 | 7.7 ± 0.2 | 0.0 ± 0.0 | ND | 0.1 ± 0.2 | 0.2 ± 0.3 |
| | Day 14 | 6.8 ± 0.0 | ND | ND | ND | 0.0 ± 0.0 |

* ND (Not detected)

Based on the above description, it will be understood by those skilled in the art that the present disclosure may be implemented in a different specific form without changing the technical spirit or essential characteristics thereof. In this regard, it should be understood that the above embodiment is not limitative, but illustrative in all aspects. The scope of the present disclosure is defined by the appended claims rather than by the description preceding them, and therefore all changes and modifications that fall within the metes and bounds of the claims, or equivalents of such metes and bounds, are intended to be embraced by the claims.

1-9. (canceled)

10. A method for reducing spore-forming microorganisms in a food, comprising: adding an antibacterial composition comprising a green tea extract during the process of preparing the food.

11. The method of claim 10, wherein the food is a retort food.

12. The method of claim 10, wherein the food has a pH of 4 to 8.

13. A method for preparing retort soups or sauces, comprising the steps of:
adding an antibacterial composition comprising a green tea extract to soups or sauces; and
subjecting the soups or the sauces comprising the to retort processing.

14. The method of claim 11, wherein the retort food comprises soups or sauces.

15. The method of claim 10, wherein the spore-forming microorganism is heat-resistant spore-forming microorganism.

16. The method of claim 10, wherein the spore-forming microorganism is Bacillus sporothermodurans.

17. The method of claim 10, wherein the green tea extract comprises polyphenols.

18. The method of claim 17, wherein the polyphenol comprises catechins.

19. The method of claim 18, wherein the catechins are any one or more selected from the group consisting of epigallocatechin gallate, epigallocatechin, epicatechin, epicatechin gallate, gallocatechin gallate, and DL-catechin.

20. The method of claim 10, wherein the food comprises the antibacterial composition in an amount of 0.05% (w/w) or more and 1% (w/w) or less.

21. The method of claim 13, wherein the antibacterial composition inhibits spore-forming microorganisms in the retort soups or sauces.

22. The method of claim 21, wherein the spore-forming microorganism is heat-resistant spore-forming microorganism.

23. The method of claim 21, wherein the spore-forming microorganism is Bacillus sporothermodurans.

24. The method of claim 13, wherein the green tea extract comprises polyphenols.

25. The method of claim 24, wherein the polyphenol comprises catechins.

26. The method of claim 25, wherein the catechins are any one or more selected from the group consisting of epigallocatechin gallate, epigallocatechin, epicatechin, epicatechin gallate, gallocatechin gallate, and DL-catechin.

27. The method of claim 13, wherein the retort soups or sauces comprise the antibacterial composition in an amount of 0.05% (w/w) or more and 1% (w/w) or less.
